(19) United States
(12) Patent Application Publication
(10) Pub. No.: US 2025/0355016 A1
(43) Pub. Date: Nov. 20, 2025

(54) NONLINEAR DAMPING IN OPTICAL FIBER ANEMOMETRY

(71) Applicant: Government of the United States as represented by the Secretary of the Air Force, Wright-Patterson AFB, OH (US)

(72) Inventors: Hengky Chandrahalim, Beavercreek, OH (US); Jeremiah Williams, Albuquerque, NM (US)

(21) Appl. No.: 19/092,505

(22) Filed: Mar. 27, 2025

Related U.S. Application Data
(60) Provisional application No. 63/648,396, filed on May 16, 2024.

(51) Int. Cl. G01P 5/26; G01P 1/00

(52) U.S. Cl. CPC G01P 5/26; G01P 1/00

(57) ABSTRACT

A flow sensing system including a light source and a light sensor; an optical fiber including a fiber core exposed at a face of the optical fiber; an anemometer for measuring a fluid flow, the anemometer including: a stator; a rotor including one or more blades having a reflective surface for reflecting light from the fiber core back into the fiber core for measurement by the light sensor; and a gap between the stator and the rotor. The anemometer is positioned at the face of the optical fiber such that, as the rotor rotates, the blades of the rotor pass the fiber core reflecting light from the light source back into the fiber core, the fiber core receives the light reflected by the reflective surface and transmits it to the light sensor, and a stabilizing agent is filled in the gap between the stator and the rotor.

### CROSS-REFERENCE TO RELATED APPLICATIONS

Pursuant to 37 C.F.R. § 1.78(a)(4), this application claims the benefit of and priority to prior filed co-pending Provisional Application Ser. No. 63/648,396, filed May 16, 2024, which is expressly incorporated herein by reference in its entirety. This application is also related to U.S. Pat. No. 11,635,315, entitled, “Optical Fiber Tip Anemometer” and incorporates this reference in its entirety.

### RIGHTS OF THE GOVERNMENT

The invention described herein may be manufactured and used by or for the Government of the United States for all governmental purposes without the payment of any royalty.

### FIELD OF THE INVENTION

The present invention relates generally to microscopic sensors and, more particularly, to microscopic passive optical sensors fabricated on a tip of an optical fiber and methods of fabricating same.

### BACKGROUND OF THE INVENTION

Accurate measurement of fluid flow rates is crucial in various applications, ranging from industrial processes to environmental monitoring. Traditional methods for fluid flow measurement often rely on anemometers, which are designed to detect the speed and direction of fluid flow. However, most conventional anemometers suffer from significant limitations, particularly in providing consistent periodic responses during measurements. These inconsistencies can arise from factors such as mechanical wear, environmental disturbances, or dynamic changes in the fluid's properties, leading to fluctuating or unreliable readings. They can also be introduced do to insufficient design.

Current anemometers, including those based on mechanical and optical principles, often fail to maintain a stable and predictable periodic response throughout extended use or under varying fluid conditions because of mechanical forces (e.g., friction) developed based on movement of parts of the anemometers. As a result, flow measurements may be prone to errors, reducing the accuracy and reliability required for critical applications. Furthermore, without a consistent response, real-time monitoring and precise control of fluid systems become challenging, potentially compromising performance and system stability. Accordingly, systems that display an ability to measure flow with a consistent periodic response may be required.

### SUMMARY OF THE INVENTION

The present invention overcomes the foregoing problems and other shortcomings, drawbacks, and challenges of current flow sensing systems. While the invention will be described in connection with certain embodiments, it will be understood that the invention is not limited to these embodiments. To the contrary, this invention includes all alternatives, modifications, and equivalents as may be included within the spirit and scope of the present invention.

According to one embodiment of the present invention a fluid flow sensing system includes a light source and a light sensor; an optical fiber including a fiber core exposed at a face of the optical fiber such that light from the light source can pass out of and into the fiber core; an anemometer for measuring a fluid flow, the anemometer including: a stator; a rotor including one or more blades having a reflective surface for reflecting light from the fiber core back into the fiber core for measurement by the light sensor; and a gap between the stator and the rotor. The anemometer is positioned at the face of the optical fiber such that, as the rotor rotates, the blades of the rotor pass the fiber core reflecting light from the light source back into the fiber core, the fiber core receives the light reflected by the reflective surface and transmits it to the light sensor, and a stabilizing agent is filled in the gap between the stator and the rotor.

According to another embodiment, an anemometer for measuring a fluid flow includes a stator; a rotor including one or more blades having a reflective surface for reflecting light from a fiber core back into the fiber core for measurement by a light sensor; and a gap between the stator and the rotor, wherein a stabilizing agent is filled in the gap between the stator and the rotor.

According to yet another embodiment, a flow sensing system includes a light source; a light sensor; and a micro, optomechanical anemometer including an optical fiber including a fiber core exposed at a face of the optical fiber such that light from the light source can pass out of and into the fiber core; a stator; a rotor including one or more blades having a reflective surface for reflecting light from the fiber core back into the fiber core for measurement by the light sensor; and a gap between the stator and the rotor. The micro, optomechanical anemometer is positioned at the face of the optical fiber such that, as the rotor rotates, the blades of the rotor pass the fiber core reflecting light from the light source back into the fiber core, the fiber core receives the light reflected by the reflective surface and transmits it to the light sensor, and a stabilizing agent is filled in the gap between the stator and the rotor.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the present invention and, together with a general description of the invention given above, and the detailed description of the embodiments given below, serve to explain the principles of the present invention.

FIG. 1 shows a 3D optomechanical flow sensor, according to one or more embodiments shown and described herein.

FIG. 2 shows additional details of the flow sensor of FIG. 1.

FIG. 3 shows additional details of a flow sensor, similar to the flow sensor of FIG. 1.

FIG. 4 shows a process of manufacturing a flow sensor similar to the flow sensor of FIG. 1.

FIG. 5 shows additional details of a flow sensor, similar to the flow sensor of FIG. 1.

FIG. 6 shows a process for inserting a damping agent to a flow sensor, similar to the flow sensor of FIG. 1.

FIG. 7 shows a system for testing a flow sensor similar to the flow sensor of FIG. 1.

FIG. 8 shows results of testing a flow sensor using a system similar to the system shown in FIG. 7.

FIG. 9 shows further results of testing a flow sensor using a system similar to the system shown in FIG. 7.

FIG. 10 shows additional aspects of a system for testing flow using an anemometer, similar to the flow sensor of FIG. 1.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

As discussed herein, current anemometers may lack an ability to measure flow with a consistent periodic response. Disclosed herein is a solution that addresses these issues: a dynamic, fiber tip anemometer with a 3D rotor, fabricated using a two-photon nanomachining process, that revolves around a stator. The anemometer is monolithically integrated onto the cleaved face of an optical fiber, serving as an integrated waveguide. Nonlinear damping—a fourth dimension—is realized by infusing a stabilizing agent into a gap between the rotor and stator via monolithically integrated dual-function microfluidic channels. This enhancement enables consistent periodic measurement of gaseous nitrogen flow rates between 10 and 20 LPM. The dynamic nature of the sensing element allows for precise measurement of gaseous fluid flow with a minimal sensor footprint at the point of detection. Since no optical resonance is required, it supports a variety of optical sources and measurement devices without requiring specific wavelengths or broad-spectrum capabilities.

The following examples illustrate particular properties and advantages of some of the embodiments of the present invention. Furthermore, these are examples of reduction to practice of the present invention and confirmation that the principles described in the present invention are therefore valid but should not be construed as in any way limiting the scope of the invention.

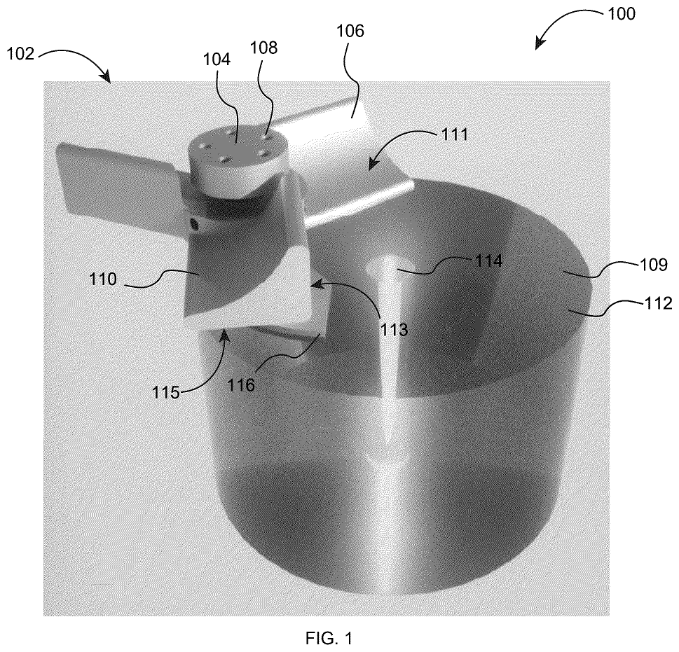

Referring to FIG. 1, a flow sensor system 100, which may be a 3D optomechanical flow sensor system, is shown. The flow sensor system 100 includes an aerodynamic element 102 that includes a stator 104 and a rotor 106. The stator 104 may include multiple channels 108 that can be used to deliver damping agent to one or more portions of the aerodynamic element 102 as will be explained in greater detail herein. The rotor 106 includes multiple blades 110. The aerodynamic element 102 may be positioned at a tip of an optical fiber 112. The optical fiber 112 may include a fiber core 114 and the aerodynamic element 102 may be positioned on the tip of the optical fiber 112 using an adhesion pad 116.

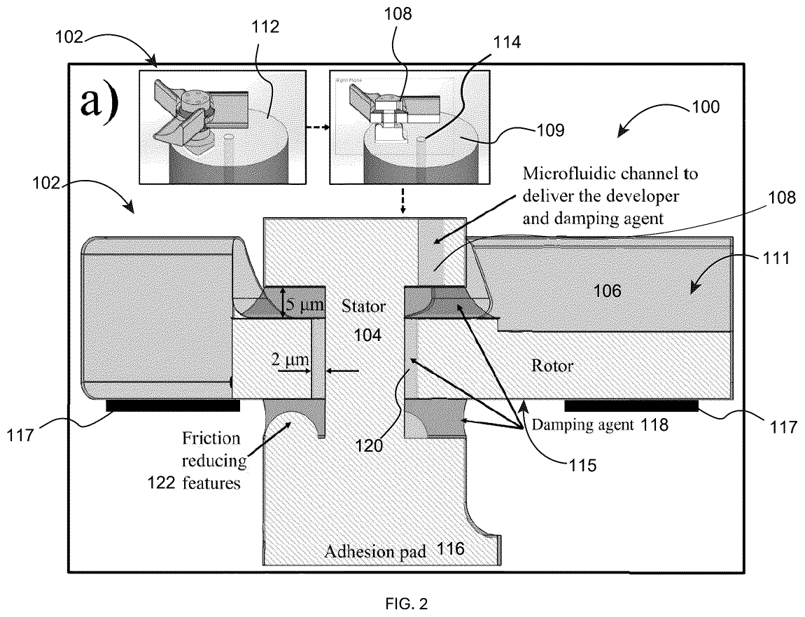

FIG. 2 shows additional details of the flow sensor system 100. Between the stator 104 and the rotor 106, there may be various gaps 120 that provide an offset between the stator 104 and the rotor 106, permitting the rotor 106 to rotate with respect to the stator 104. In embodiments, the gaps 120 may be filled with a damping agent 118 via the channels 108. Additionally, the aerodynamic element 102 may include one or more friction reducing features 122 that reduce the friction between the stator 104 and the rotor 106.

As mentioned, the rotor 106 may include one or more blades 110. The blades can be of any size and shape. For instance, in some embodiments, the rotor 106 including blades 110 may have a diameter of ˜110 μm. In some embodiments, the anemometer may be designed such that it operates on the same propeller mechanics of an airplane. The blades 110 may generate thrust perpendicular to their direction of travel around the stator 104. As shown in FIGS. 1 and 2, the blades 110 may have a curved, cup-like profile on a top surface 111 and a flat front surface 113 that is generally parallel to a direction of fluid flow, as described in greater detail herein.

The blade 110 also includes a bottom surface 115, which may pass over the fiber core 114 as the rotor 106 rotates around the stator 104. The stator 104 may be affixed to the cleaved face of the optical fiber 112. The rotor 106 can rotate in reaction to axial fluid flow impacting the blades 110 (e.g., three cup-like microblades). The blades 110 and rotor 106 spin faster under higher flow rates. The bottom surface 115 of each blade 110 incorporates a reflective surface 117. The reflective surface 117 is a highly reflective, flat surface coating (e.g., a highly reflective gold coating), aligned parallel to the fiber face 109. As the rotor 106 spins, the reflective surfaces 117 sequentially pass over the fiber core 114, reflecting light back through the fiber 112 whenever they align with the fiber core 114.

FIG. 2 also shows a cross-sectional representation of the stator 104 and the rotor 106 including the channel 108. The channel 108 may be a microfluidic channel that is used to deliver resin developer fluid and damping agent 118. As shown, the rotor 106 can include multiple channels 108. The channels 108 can have any suitable diameter, for example, the channels 108 may have a diameter of 1 μm, 2 μm, 4, μm, etc. The channels 108 can facilitate precise fluid management, which may optimize both the development process and the stabilization of mechanical components within the system. The various aspects of the system 100 may be designed using, for example, a computer aided design (CAD) platform (e.g., 3D CAD software).

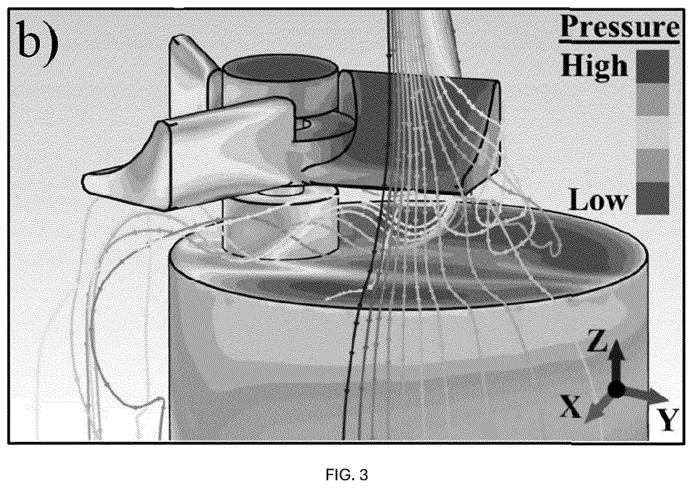

FIG. 3 shows a computational fluid dynamics analysis examining the complex aerodynamic effects on the microblades and the fiber tip. A simulated 3D image displays erratic path lines around the microblades and the fiber tip. Different shades represent varying pressures, while the flow lines are distinctly shaded to enhance visual clarity.

Given the conditions under which this device operates, the flow regime may be determined to be incompressible. In some embodiments, a Mach number may be calculated at 0.15 for the highest observed flow rate. This value is well below the threshold of 0.3 that typically indicates a transition to compressibility. The dynamic pressure from the flow can be calculated using the formula P=ρν²/2, where ρ is the density of the flow and ν is the velocity of the flow. The microblade design induces both radial and axial reaction forces; the radial force facilitates rotation, while the axial force presses the rotor against the stator base. Rotation is resisted by the drag of the blades, along with friction at both the center post and the base of the stator.

The fiber can act as a low-loss waveguide, allowing the light source and measurement equipment to be distanced from the sensing point. At the fiber's opposite end, the reflected light can be isolated by an optical circulator and measured using an optical power meter and oscilloscope. The frequency of the reflection events may correlate with the rotational velocity of the rotor 106, which in turn, depends on the velocity of the incident flow.

The dynamics involved in flow sensing experiments are often more complex than those described by theoretical analytic models. A more realistic perspective can be gained on the operation of this fiber optic flow sensor using a computational fluid dynamics (CFD) analysis. Additional information related to the parameters used in the CFD analysis conducted in this study is available herein. The 3D image in FIG. 3 qualitatively illustrates several random path lines surrounding the blades 110 and the fiber 112, highlighting areas of high pressure located behind, underneath, and in front of the blade 110. These areas indicate significant out-of-plane flow (directed toward the post) caused by the fiber face. Upon examining the top and bottom of the rotor, one can observe the varying pressures that the individual blades experience as they pass over the fiber. This complex aerodynamic situation can lead to irregular rotation of the microblades. Additionally, as depicted in FIG. 2, there is a 2 μm air gap between the rotor and stator. This gap facilitates dry adhesive friction and rotation instability between the rotor and stator, which may cause potential issues during flow sensing experiments. In order to address this issue, the aerodynamic element 102 includes one or more microfluidic channels 108 (e.g., five 4-μm diameter dual-function microfluidic channels). These channel(s) serve a dual purpose: delivering developer fluid to cure the photosensitive resin and transporting the stabilizing agent into the gap 120 between the stator 104 and rotor 106. This microfluidic design ensures precise fluid management, optimizing both the resin development process and the stabilization of mechanical components within the fiber tip anemometer microsystem. The CFD analysis is primarily illustrative, visualizing the dynamics involved in the study without quantifying any specific parameters.

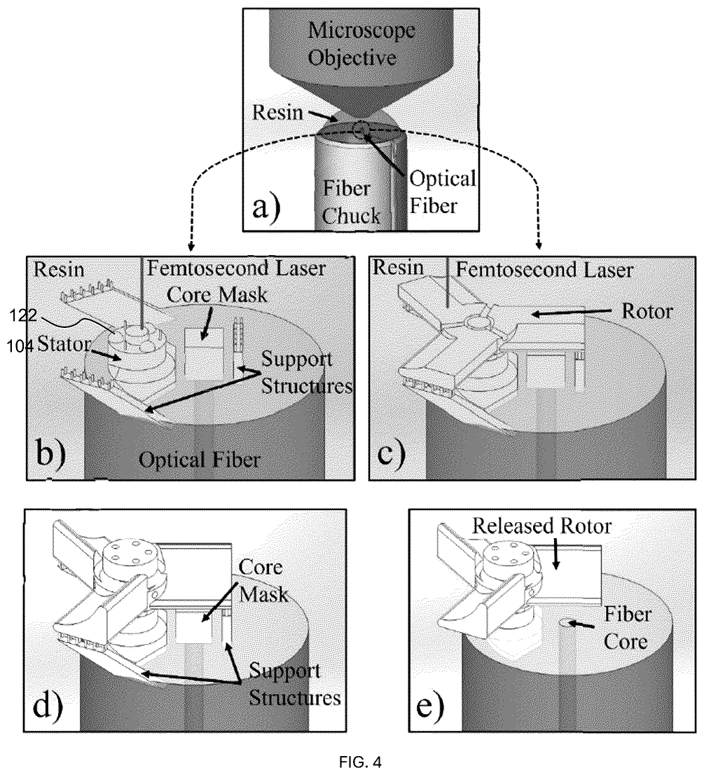

FIG. 4 shows a manufacturing process for manufacturing the flow sensor system 100 of FIGS. 1-3. The flow sensor system 100 may be manufactured, for example, using a two-photon polymerization (2PP) nanomachining technique with a Nanoscribe GT Photonic Professional 2PP system. This method solidifies photoactive resin similarly to stereolithography but utilizes two photons at half the wavelength required for single-photon polymerization to impart the resin's polymerization energy. The precision of the laser beam allows for the creation of voxels (3D pixels) as small as 200 nm×200 nm×200 nm. The detailed laser inscription process for the fiber tip optomechanical anemometer is depicted in FIG. 4, Parts a), b), c), d), and e).

During fabrication, a cleaved fiber can be secured in a side-loading fiber chuck, and a drop of photoactive resin may be deposited onto the chuck's face to envelop the fiber. The fiber can be aligned with the laser using a custom jig attached to the sample mounting plate, as shown in Part a) of FIG. 4. The anemometer features a lateral resolution of 200 nm×200 nm and layer heights of 300 nm. The manufacturing process can include manufacturing breakable support structures for each rotor blade and a masking cap over the fiber core (shown in Part b) of FIG. 4). Twelve 1 μm pillars connect the blades to the support structures, and a 20 μm cube serves as the masking cap. The stator's inner pillar can have a diameter of 12 μm with a clearance of 2 μm from the rotor.

In some embodiments, five 4-μm diameter dual-function microfluidic channels can be incorporated to facilitate the entry of propylene glycol monomethyl ether acetate (PGMEA) solution into these tight clearances, aiding in the development of the photosensitive resin and delivering the damping agent between the stator and rotor. Additionally, three hemispherical features (friction reducing features 122) can be patterned on the base of the stator to minimize friction with the rotor. The nonpolymerized resin can be developed in PGMEA for 20 minutes. Halfway through this process, the fiber can be extended several millimeters for the final 10 minutes to prevent resin droplets from forming around the device. Subsequently, the device can be cleaned in isopropyl alcohol (IPA) for 10 minutes to remove any residual PGMEA, as illustrated in Part d) of FIG. 4.

The support pillars that maintain the microblades during the 2PP process, shown in Parts b), c), and d) of FIG. 4, can be removed with a semiconductor analysis probe. This procedure may require dexterity at the level needed for precise wire bonding or device probing. Additional details about the 2PP process parameters and the photosensitive resin used in fabricating the fiber tip flow sensors are available herein. The support material can be removed by securing the fiber in a side-loading fiber chuck, which can then be positioned into a fiber chuck holder. This assembly can be placed beneath a Micromanipulator probe station within a stainless-steel block. Removal may be facilitated using a magnetic probe arm paired with a semiconductor analysis probe. The masking cube can be removed using the same procedure, exposing the core of the fiber.

In one example of the 2PP process, a 780 nm femtosecond laser featuring a 120-fs pulse duration, an 80 MHz repetition rate, 40% laser power, and a scan speed of 10 mm/s can be employed. The laser, directed by galvanometric control, can solidify the photosensitive resin. To facilitate the alignment of the device on the fiber tip, red light from a flashlight can be coupled into the fiber to illuminate the fiber core. A small disk on each device can serve as an alignment mark, which can be aligned with the core to ensure the device is accurately centered on the fiber tip. This alignment can be achieved by focusing the laser inside the fiber, where the light may be visible but not yet causing polymerization of the resin.

The reflective surface 117 shown in FIG. 2 (e.g., gold film) can be deposited onto the device using a magnetron sputtering system. The device can be positioned on a rotating platen with the blades aligned approximately orthogonal to the sputtering target. The sputtering can be conducted at a pressure of 5 mTorr and a power setting of 100 Watts for 5 minutes. While the reflective surface 117 can render the device visually reflective, determining the precise thickness of the coating necessary to achieve reflectivity may be challenging due to the angle of the blades 110 relative to the target and interference from the fiber face. A magnetron plasma sputtering system can be utilized for the deposition of a gold film on the flow sensor. Exemplary parameters used for gold deposition are detailed in Table 1.

TABLE 1

| Parameters | Values | |
|---|---|---|
| Cathode Power | 100 | Watt |
| Cathode Mode | DC | |
| Burn-in Time | 30 | seconds |
| Burn-in Pressure | 10 | mTorr |
| Deposition Pressure | 5 | mTorr |
| Stage Rotation | 5 | rpm |
| Fiber Position | Center Stage | |
| Deposition Time | 300 | seconds |

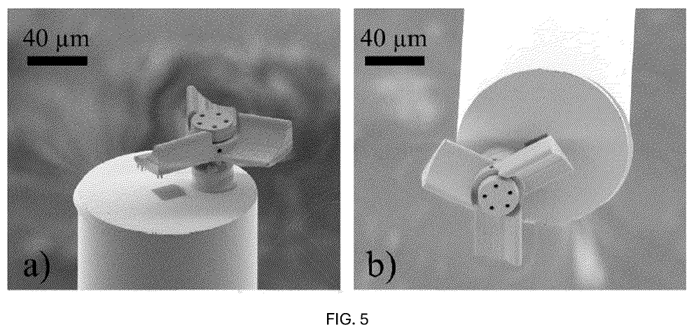

During sputtering, a sacrificial polymer brick may be placed over the fiber core to protect it. This brick may be subsequently removed in a manner similar to that used for the blade supports, achieved most effectively by applying upward pressure with the very tip of the probe to peel it from the fiber tip. Following this procedure, the fiber tip anemometer may be ready for testing and/or use. The final schematic of the anemometer post-removal of the support structures and sacrificial brick is depicted in Part e) of FIG. 4. FIG. 5 depicts scanning electron microscope images of the fabricated fiber tip anemometer.

As previously mentioned herein, the complex aerodynamic environment around the sensing element at the fiber tip can cause sporadic and irregular rotation of the microblades in response to incident flow after support removal. Additionally, a 2 μm air gap between the rotor and stator can introduce dry adhesive friction and rotation instability, complicating flow sensing experiments. To address these challenges, it can be advantageous to use one or more fluid quadrivium stabilizing agents, regarded as the fourth dimension. These agents can be injected through dual-purpose microfluidic channels (five 4-μm diameter microfluidic channels) into the anemometer to fill the gap and stabilize the rotor's rotation.

In some embodiments, a low-viscosity liquid that repels gold on the surface of the anemometer but is attracted to the walls of the microfluidic channels is used in the manufacturing process. Essentially, the gold film acts as a hydrophobic surface while the microfluidic holes must be hydrophilic to attract the stabilizing agent. An exemplary effective and suitable stabilizing agent can be composed of 85-95% low volatile petroleum (LVP) aliphatic hydrocarbon and 1-5% polydimethylsiloxane. A high percentage of LVP aliphatic hydrocarbon can ensure low volatility, enhancing the oil's stability and consistency in performance, while the polydimethylsiloxane can contribute to thermal stability and lubrication. This carefully balanced formulation may be ideal for use between the rotor and stator of the anemometer, where precise interaction with the device's components is crucial.

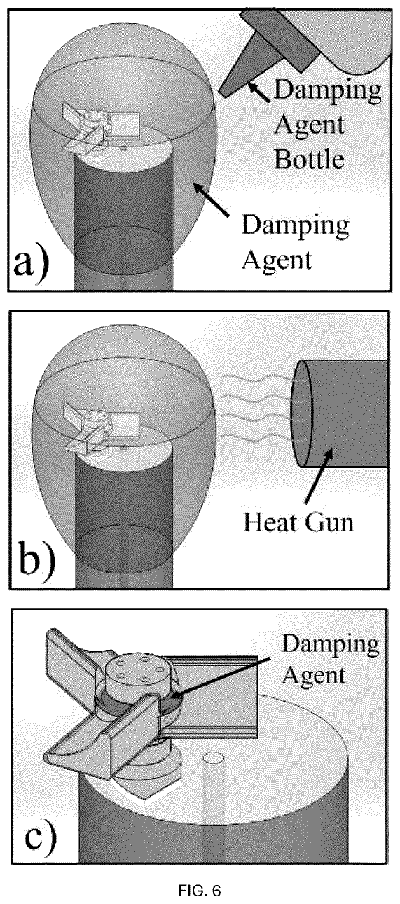

FIG. 6 depicts an application process of the stabilizing agent. In some embodiments, the stabilizing agent (e.g., a polydimethylsiloxane hydrocarbon damping agent) is dripped over the entire structure (as shown in FIG. 6, Part a)). This can be followed by approximately 5 minutes of exposure to a heat gun to dry the device's exterior (as represented in FIG. 6, Part b)). The application of heat ensures the oil remains within the clearances between the rotor and stator. The polydimethylsiloxane hydrocarbon stabilizing medium integrated into the fiber tip anemometer stabilizes the rotor's spin, allowing for reliable measurement and extraction of rotational frequency (FIG. 6, Part c)).

The terms ‘stabilizing medium,’ ‘stabilizing agent,’ ‘damping medium,’ and ‘damping agent’ are used interchangeably throughout this article. One exemplary stabilizing agent can be formulated with 85-95% low volatile petroleum (LVP) aliphatic hydrocarbon and 1-5% polydimethylsiloxane. Aliphatic hydrocarbons are compounds consisting mainly of carbon and hydrogen atoms, arranged in straight chains, branched chains, or non-aromatic rings. They are known for being less reactive compared to aromatic hydrocarbons. LVP aliphatic hydrocarbons have low volatility, meaning they have a higher boiling point and evaporate slower than other hydrocarbons. This property makes them useful in applications where minimal evaporation is desired, such as in lubricants. Polydimethylsiloxane belongs to a group of polymeric organosilicon compounds that are commonly referred to as silicones. The structure of polydimethylsiloxane is typically represented as [—Si(CH₃)₂—O—]_n, showing a silicon-oxygen backbone with pendant methyl groups. It is known for its flexibility, low toxicity, thermal stability, and hydrophobic characteristics. It provides excellent lubrication, is stable over a wide range of temperatures, and is resistant to water and many chemicals. When these two components are combined, the LVP Aliphatic Hydrocarbon acts as a carrier or diluent, enhancing the spreadability and reducing the overall viscosity of the mixture. Meanwhile, the polydimethylsiloxane provides the main mechanical stabilizing properties, adds thermal stability, and contributes to the chemical inertness of the oil. This combination makes this material suitable for a variety of applications, including mechanical stabilization in environments where both lubrication and stability are critical under varying temperature and pressure conditions. In the context of optomechanical fiber anemometry, this polydimethylsiloxane hydrocarbon helps stabilize the mechanical parts while ensuring that the oil's properties remain consistent during operation.

An optical fiber may be initially prepared by cleaving it with a high-precision fiber cleaver. The fiber can then be secured into a fiber chuck, allowing approximately 0.5 mm of the fiber to extend beyond the end of the chuck. A drop of UV-curable resin can be applied to the end of the fiber chuck, fully enveloping the fiber tip. Subsequently, the chuck can be attached to a custom 3D-printed jig, which was then mounted onto a 2-inch wafer plate. This plate may have three accessible threaded holes, facilitating secure mounting. The assembly can then be adjusted so that the laser aperture (which may be equipped with a custom 63× objective lens) can make direct contact with the resin droplet on the fiber tip. The cleaved face of the fiber can be manually positioned by an operator to align precisely with the laser focus. To enhance adhesion to the fiber face, a 5 μm thick pad can be incorporated at the base of the optical cavity. The height of this adhesion pad can be manually set by the operator to sit just below the fiber's surface, ensuring that polymerization occurs as close to the fiber surface as possible. This setup effectively secured the polymerized structure to the fiber, optimizing the integrity and stability of the fabrication.

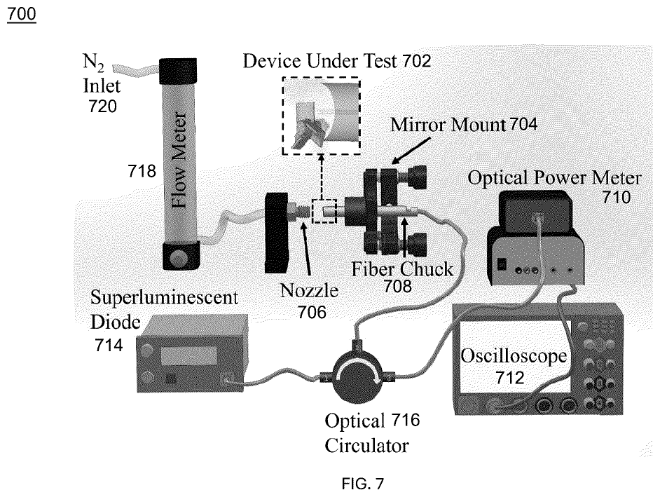

The measurement setup 700 for the fiber tip optomechanical anemometer, or flow sensor system 100, is illustrated in FIG. 7. The measurement setup 700 includes a Device Under Test (DUT) 702, a mirror mount 704, a nozzle 706, a fiber chuck 708, an Optical Power Meter 710, an oscilloscope 712, a super-luminescent diode 714, an optical circulator 716, a fluid flow meter 718, and a nitrogen (N₂) inlet 720.

The DUT 702 can be secured within the fiber chuck 708, which may be a ¼-inch diameter, side-loading fiber chuck. The DUT 702 may be attached to the mirror mount 704 using an appropriate adapter. Fluid flow (e.g., N₂ flow) can be directed through the flow meter 718 and emitted from the nozzle 706 (e.g., a ⅛-inch pressure fitting). The DUT 702 can be precisely aligned using the mirror mount 704 and monitored under a microscope while conditions are altered in order to determine which conditions achieve the fastest rotor rotation.

For illumination, the super-luminescent diode 714 can be connected to the first port of the optical circulator 716, serving as the light source. Importantly, the wavelength of the light for this sensor is not critical; therefore, any wavelength that can propagate through the fiber 112 is suitable. The DUT 702 can be connected to the second port of the optical circulator 716, with the reflective output isolated and collected at the third port. This light output can be measured using the optical power meter 710 and recorded by the oscilloscope 712. Alternative sensing equipment, such as a diode light source and a photodiode detector, could be used in place of the optical power meter 710 and oscilloscope 712 to achieve a more compact system design. Additional information about the equipment and components used in the characterization of the optomechanical flow sensors in this study is available herein.

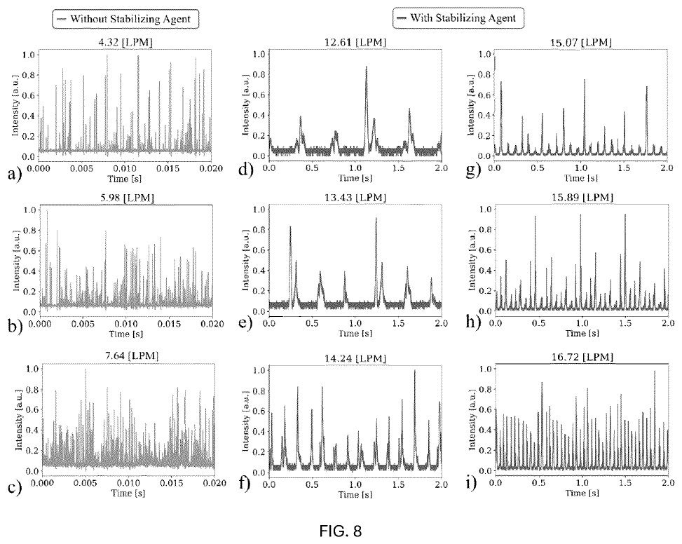

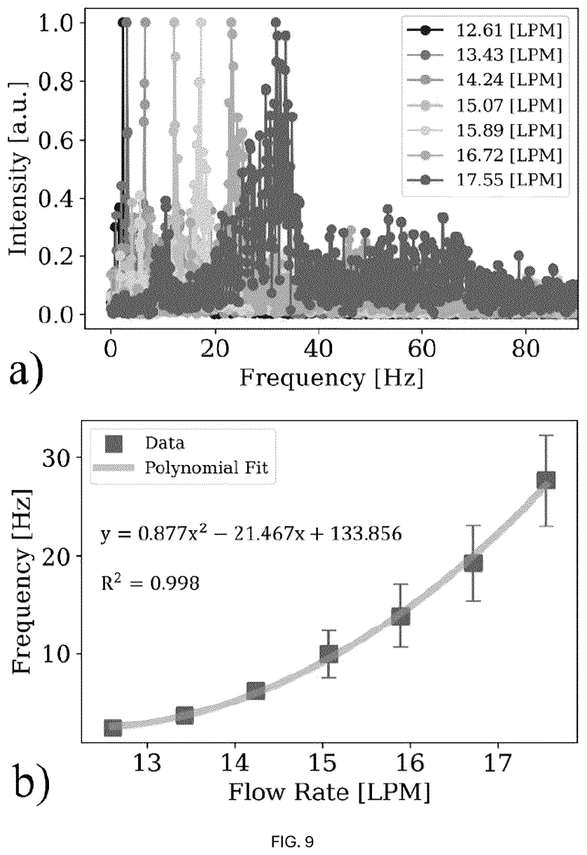

As described herein, especially with respect to FIG. 8 and FIG. 9, the optomechanical fiber tip anemometer can be characterized using the experimental setup described in FIG. 7. The optical circulator 716 can be utilized to isolate the reflection spectrum from the flow meter 718. This optical circulator 716 can transmit light from ports 1 to 2 and from 2 to 3, experiencing approximately 1 dB of insertion loss. It can also prevent transmission in the opposite direction, achieving about 40 dB of attenuation. In some embodiments, the superluminescent diode 714 is a fiber-coupled superluminescent diode (SLD) broadband source that is connected to port 1. This source can emit a spectrum of 200 nm centered at 1550 nm. The reflection spectrum from the flow meter 718 can be isolated and routed through port 3 of the optical circulator 716 to the optical power meter 710 and the digital oscilloscope 712.

During testing, the fluid flow can be incrementally increased. In some embodiments using incremental increases in fluid flow, each level of fluid flow can be maintained for at least 60 seconds to allow the rotor's rotation to stabilize before recording the data. This procedure can be repeated and in some trials, flow may return to zero between trials. This procedure can ensure a consistent orientation of the device throughout the measurements.

During such testing, the fiber tip anemometer may occasionally generate reflection peaks with varying amplitudes. This may be due to changes in the angle between the rotor mirrors and the fiber face. This variability can complicate frequency domain analysis, as lower frequencies may tend to predominate. To mitigate this issue, several processing steps of the raw data from the oscilloscope 712 may be performed. For example, first, data may be processed by taking the absolute value to eliminate noise below zero. Additionally, normalizing each measurement on a scale from one to one hundred based on the minimum and maximum intensity values may be performed. Subsequently, the logarithm of the data may be subjected to a fast Fourier transform (FFT). This processing strategy can reduce the impact of amplitude variation and allow the FFT to consistently identify the dominant frequency observed in qualitative assessments.

The algorithm employed to process the oscilloscope data may be both straightforward and practical, ensuring ease of implementation for real-world applications of the fiber tip optomechanical anemometer. By utilizing a series of concise steps—taking absolute values, normalizing measurements, and applying an FFT—this method effectively minimizes amplitude variation and reliably identifies dominant frequencies. Such simplicity in data processing not only enhances the usability of the anemometer in diverse settings but also ensures that users can achieve accurate and consistent results without the need for complex computational resources.

Measurement of operation of the device before and after injection of the stabilizing medium gives a comparison of its behavior. The flow sensor's responses without a damping medium at three randomly selected flow rates are presented in FIG. 8, Parts a), b), and c). Responses with a damping agent at six different flow rates are reported in FIG. 8, Parts d), e), f), g), h), and i). Without the stabilizing medium, the device may spin at a lower flow rate but may not maintain a consistent frequency. In contrast, the flow sensor with a damping medium may demonstrate a periodic response, facilitating precise frequency domain analysis. The anemometer's responses can be analyzed using an FFT and dominant frequency components may be evident.

The frequency domain response of each measurement from the flow sensor with an integrated damping agent is presented in FIG. 9, Part a). The spectral blur observed at higher flow rates can be attributed to the physical shaking of the fiber, as visually observed through the optical microscope at these higher flow rates. In real flow sensing measurements, a robust ferrule that encases the exposed fiber section may be necessary to eliminate this undesired physical vibration and to allow for a broader measurement range. The average of the four most prominent frequency components was taken as the sensed result of the flow. The extracted frequencies as a function of flow rate are plotted in FIG. 9, Part b), with the mean and standard deviation calculated from the two recorded experiments. The response fits well to a second-order polynomial and offers significantly improved consistency compared to the anemometer without a stabilizing agent. The relationship between the rotor's rotational velocity and the velocity of the incident flow, along with the origin of the nonlinear response of the frequency as a function of flow rate depicted in FIG. 9, Part b), is explained herein.

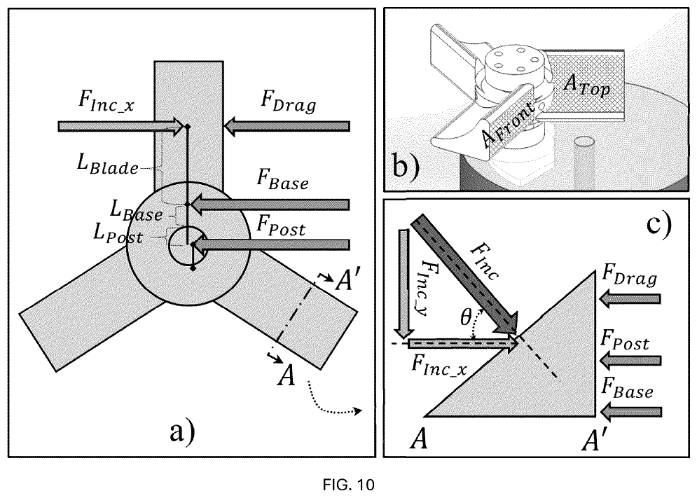

The shape of the microblades generates both radial and axial reaction forces. The radial force propels the rotation, while the axial force presses the rotor against the base of the stator. Opposition to the rotation arises from the drag of the blades, as well as friction at the center post and the base of the stator, as illustrated in FIG. 10. In an idealized steady state, the forces acting on the rotor include the radial force due to the incident flow (F_{Inc_x}), the drag force of the rotor blades (F_{Drag}), the friction force at the base of the stator (F_{Base}), and the friction at the stator post (F_{Post}). At a given steady state, these forces balance to zero net force, thereby maintaining a constant rotational velocity.

The rotational velocity of the rotor is directly related to the velocity of the incident flow, as demonstrated by taking the sum of moments around the central axis of the rotor. At steady state, this yields the following equation:

$$\sum M = {M}_{Inc \_ x} - {M}_{Base} - {M}_{Post} - {M}_{Drag} = 0 , \qquad ( 1 )$$

where M_{Inc_x}, M_{Base}, M_{Post}, and M_{Drag} are the moments generated by F_{Inc_x}, F_{Base}, F_{Post}, and F_{Drag}, respectively.

Expanding Equation (1) to include the contributing forces results in the following expression:

$${F}_{Inc \_ x} \cdot {L}_{Blade} = [ {μ}_{k} \cdot {F}_{Inc \_ y} \cdot {L}_{Base} ] + [ {μ}_{k} \cdot ( {F}_{Cent} + {F}_{G} ) \cdot {L}_{Post} ] + [ {F}_{Drag} \cdot {L}_{Blade} ] , \qquad ( 2 )$$

where μₖ is the coefficient of kinetic friction, F_{cent} is the centripetal force on the rotor, and F_{G} is the force of gravity acting on the rotor, given that the fiber is oriented horizontally during flow sensing. L_{Blade}, L_{Base}, and L_{Post} are the geometrical parameters defined in FIG. 10.

The anemometer studied here features three identical rotor blades. This configuration allows for the analysis of just one blade to understand the kinematics of the entire system. By expanding the forces described in Equation (2) for one rotor blade, the following expression can be obtained:

$$\frac{1}{2} {ρ}_{{N}_{2}} {v}_{{N}_{2}}^{2} {A}_{Top} cos θ {L}_{Blade} = [ {μ}_{k} \frac{1}{2} {ρ}_{{N}_{2}} {v}_{{N}_{2}}^{2} {A}_{Top} sin θ {L}_{Base} ] + [ {μ}_{k} ( \frac{1}{3} {mL}_{Post} {ω}^{2} + \frac{1}{3} mg ) {L}_{Post} ] + [ {C}_{d} {A}_{Front} \frac{{{ρ}_{{N}_{2}} ( {L}_{Blade} ω )}^{2}}{2} {L}_{Blade} ] , \qquad ( 3 )$$

where θ, A_{Top}, and A_{Front} are geometrical parameters defined in FIG. 10. The variables ρ_{N2}, ν_{N2}, m, C_{d}, g, and ω represent the density of the nitrogen flow, the velocity of the nitrogen flow, the mass of the rotor, the drag coefficient, the acceleration due to gravity, and the rotor's rotational velocity, respectively.

Equation (3) can be rearranged to reveal the relationship between the rotor's rotational velocity, ω, and the velocity of the incident flow, ν_{N2}, as shown in the following equation:

$${ω}^{2} = {v}_{{N}_{2}}^{2} [ \frac{( \frac{1}{2} {ρ}_{{N}_{2}} {A}_{Top} cos θ {L}_{Blade} - {μ}_{k} \frac{1}{2} {ρ}_{{N}_{2}} {A}_{Top} sin θ {L}_{Base} )}{( {C}_{d} {A}_{Front} \frac{1}{2} {ρ}_{{N}_{2}} {L}_{Blade}^{3} + {μ}_{k} \frac{1}{3} {mL}_{Post}^{2} )} ] - [ \frac{( {μ}_{k} \frac{1}{3} mg {L}_{Post} )}{( {C}_{d} {A}_{Front} \frac{1}{2} {ρ}_{{N}_{2}} {L}_{Blade}^{3} + {μ}_{k} \frac{1}{3} {mL}_{Post}^{2} )} ] \qquad ( 4 )$$

Equation (4) illustrates a linear relationship between the rotor's rotational velocity and the nitrogen flow velocity, which does not fully align with experimental results. As shown in FIG. 9, the experimental data demonstrate that the rotor's rotational velocity increases nonlinearly with the flow rate.

Aerodynamic effects, such as blade design and the angle of the rotor blades, can result in complex interactions with airflow, such as turbulence, which might not be linearly proportional to the flow rate. The efficiency with which each blade converts airflow into rotational motion can vary at different flow rates, potentially leading to nonlinear behavior. However, the design mitigates such effects. As depicted in FIG. 8, the three blades of the anemometer are meticulously engineered to prevent airflow separation from the blade surfaces, which typically leads to a sudden loss of lift and an increase in drag. Experimental results, presented in FIG. 9, demonstrate that the rotational velocity of the rotor increases nonlinearly as a function of the flow rate, adhering to the second-order polynomial equation of the flow rate, adhering to the second-order polynomial equation y=0.877x²−21.467x+133.856, with R²=0.998, where y is directly related to the rotational velocity, and x denotes the flow rate. This relationship strongly suggests that aerodynamic stall does not significantly influence the measurements.

Further supporting this conclusion is the analysis of the Reynolds Number (Re), calculated using the equation Re=ρ_{N2} ν_{N2} L_{Blade}/μ_{N2}, where the dynamic viscosity of Nitrogen, μ_{N2}, is 1.78×10⁻⁵ Pa·s. Here, the flow velocity of nitrogen is conservatively estimated at 52 m/s for a flow rate of 25 LPM—well above the current operational range. The resulting Reynolds number of approximately 210 indicates laminar flow conditions, as turbulence generally occurs at Reynolds numbers significantly higher than 2000, typically observed in pipe flows or around streamlined bodies. Therefore, it can be asserted that potential aerodynamic effects that could cause a nonlinear relationship between the rotational velocity and the flow rate are negligible in the current system.

Measurement systems may potentially introduce nonlinearity into experimental results if the equipment employed exhibits inherent nonlinear characteristics. To ensure the integrity of data, verification was made that all tools used to measure flow rate and rotor frequency are linear throughout their operational ranges, particularly at the extremes of these ranges. Consequently, it can be asserted that any nonlinear characteristics observed in the results are not attributable to the measurement systems used, effectively eliminating this potential source of error in the study.

The observed nonlinear increase in rotational velocity as a function of flow rate can be attributed to the combined effects of nonlinear viscous damping and friction at the rotor-stator interface. The stabilizing medium in the gap between the rotor and stator creates a fluid coupling that reduces direct contact friction, providing smoother rotational motion and enhancing energy transfer from the flow to the rotor. This coupling helps maintain a steady speed increase by reducing mechanical friction.

As flow rate increases, the fluid coupling becomes more efficient in transferring energy to the rotor, resulting in a nonlinear increase in rotational velocity. The polydimethylsiloxane hydrocarbon stabilizing medium exhibits shear-thinning behavior, meaning its viscosity decreases with increasing shear rate. As the flow rate increases, the rotor spins faster, causing a higher shear rate in the stabilizing medium, which reduces viscosity. This reduction in viscosity decreases the damping force and allows the rotor to spin faster. Therefore, the decreasing viscosity due to shear thinning contributes to a nonlinear increase in rotational velocity with increasing flow rate.

Additionally, the rotor-stator interface exhibits a combination of boundary and hydrodynamic lubrication regimes, as described by the Stribeck curve. Initially, at lower flow rates, friction is relatively high due to boundary lubrication. However, as flow rate increases, the lubrication regime shifts towards full hydrodynamic lubrication, reducing friction nonlinearly and allowing the rotor to spin faster.

Although the mass of the stabilizing agent is non-negligible compared to the rotor and adds inertia, the fluid coupling ensures more uniform acceleration. The increase in rotational velocity follows a nonlinear trend due to the interplay between increased flow rate and the nonlinear reduction of mechanical friction and viscous damping. This nonlinear friction behavior at the rotor-stator interface, combined with the shear-thinning damping effect, results in a net increase in rotational velocity with increasing flow rate, as described by the second-order polynomial equation presented in FIG. 9.

Although linear sensor systems may offer more predictable responses and simpler calibration requirements, nonlinear systems, such as the nonlinear fiber tip anemometer presented here, can provide several key advantages over their linear counterparts. Nonlinear systems exhibit a broader measurement range due to their nonlinear response characteristics. At low flow rates, the nonlinear response curve amplifies small changes, providing high sensitivity to subtle variations. As flow rates increase, the system's nonlinear response maintains sensitivity by adapting dynamically to larger variations. Thus, the second-order polynomial relationship between flow rate and sensor output allows for accurate measurement across a wider range of flow rates. Furthermore, nonlinear systems can exhibit increased sensitivity due to the nature of their response curve. In the nonlinear anemometer presented in this study, the second-order polynomial response curve shown in FIG. 9 inherently provides varying levels of sensitivity at different flow rates. At specific flow rates, the response curve shows steep slopes, indicating high sensitivity to small changes in flow rate. For instance, in FIG. 9, the sensitivity of the flow sensor between 16.72 and 17.55 LPM is seven times higher than the sensitivity between 12.61 and 13.43 LPM. Due to the steeper slopes in the nonlinear response curve, small changes in flow rate lead to significant changes in measured rotational velocity. This characteristic enables the detection of subtle changes, even at flow rates that might not be detectable with linear sensors.

It should now be understood that a dynamic fiber tip anemometer with a 3D rotor, fabricated using a two-photon nanomachining process, that revolves around a stator can be used to increase sensitivity and accuracy in various fluid measurements. The anemometer can be monolithically integrated onto a cleaved face of an optical fiber, serving as an integrated waveguide. Nonlinear damping—the fourth dimension—can be realized by infusing a stabilizing agent (e.g., polydimethylsiloxane hydrocarbon) into the gap between the rotor and stator via monolithically integrated dual-function microfluidic channels. This enhancement can enable consistent periodic measurement of gaseous nitrogen flow rates between 10 and 20 LPM. The dynamic nature of the sensing element allows for precise measurement of gaseous fluid flow with a minimal sensor footprint at the point of detection. Since no optical resonance is required, the system supports a variety of optical sources and measurement devices without requiring specific wavelengths or broad-spectrum capabilities. This high degree of adaptability significantly reduces the overall cost of a full-fledged sensor system compared to laser-based sensors, offering a compact, versatile, and cost-effective solution for advanced flow sensing applications. Comprehensive characterizations with and without the stabilizing medium demonstrate its critical role in regulating the dynamics between the rotor and stator, ensuring reliable and periodic sensing. Additionally, systematic analysis reveals key factors influencing the anemometer's nonlinear response. The results emphasize the advantages of nonlinear systems in sensing and provide a foundation for future research into engineering nonlinear damping to enhance sensitivity within user-defined ranges. This work paves the way for exploring highly integrated sensing elements with complex, compact, and dynamic 3D mechanical and optical components, laying the groundwork for next-generation nonlinear optomechanical sensing applications in space-limited environments.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A fluid flow sensing system comprising:
a light source and a light sensor;
an optical fiber including a fiber core exposed at a face of the optical fiber such that light from the light source can pass out of and into the fiber core;
an anemometer for measuring a fluid flow, the anemometer including:
a stator;
a rotor including one or more blades having a reflective surface for reflecting light from the fiber core back into the fiber core for measurement by the light sensor; and
a gap between the stator and the rotor, wherein
the anemometer is positioned at the face of the optical fiber such that, as the rotor rotates, the blades of the rotor pass the fiber core reflecting light from the light source back into the fiber core,
the fiber core receives the light reflected by the reflective surface and transmits it to the light sensor, and
a stabilizing agent is filled in the gap between the stator and the rotor.

2. The fluid flow sensing system of claim 1, wherein the stabilizing agent comprises low volatile petroleum (LVP) aliphatic hydrocarbon.

3. The fluid flow sensing system of claim 2, wherein the stabilizing agent comprises and a polymeric organosilicon compound.

4. The fluid flow sensing system of claim 3, wherein the stabilizing agent is formulated with 85-95% low volatile petroleum (LVP) aliphatic hydrocarbon and 1-5% polydimethylsiloxane.

5. The fluid flow sensing system of claim 1, wherein the stator comprises one or more microfluidic channels for inserting the stabilizing agent into the gap.

6. The fluid flow sensing system of claim 5, wherein the microfluidic channels are 4 μm in diameter.

7. The fluid flow sensing system of claim 1, wherein the stabilizing agent induces a nonlinear damping effect, resulting in a nonlinear response characterized by a second-order polynomial relationship between fluid flow rate and rotor rotational velocity, thereby providing increased sensitivity to small variations in flow at higher flow rates compared to linear flow sensor systems.

8. The fluid flow sensing system of claim 7, the nonlinear response dynamically adapts across different fluid flow rates, providing amplified sensitivity at higher flow rates and maintaining adequate sensitivity at lower flow rates, thereby enabling higher resolution measurement across a broader operational range relative to linear flow sensor systems.

9. The fluid flow sensing system of claim 8, wherein the nonlinear damping effect and resulting nonlinear response facilitate detection of subtle variations in fluid flow rates, including variations that are not readily detectable by linear flow response sensors.

10. The fluid flow sensing system of claim 1, comprising 5 microfluidic channels.

11. An anemometer for measuring a fluid flow comprising:
a stator;
a rotor including one or more blades having a reflective surface for reflecting light from a fiber core back into the fiber core for measurement by a light sensor; and
a gap between the stator and the rotor, wherein a stabilizing agent is filled in the gap between the stator and the rotor.

12. The anemometer of claim 11, wherein the reflective surface is a gold coating coated on a bottom surface of the one or more blades.

13. The anemometer of claim 12, wherein the reflective surface is coated on all the blades of the rotor.

14. The anemometer of claim 11, wherein the stabilizing agent comprises low volatile petroleum (LVP) aliphatic hydrocarbon.

15. The anemometer of claim 14, wherein the stabilizing agent comprises and a polymeric organosilicon compound.

16. The anemometer of claim 15, wherein the stabilizing agent is formulated with 85-95% low volatile petroleum (LVP) aliphatic hydrocarbon and 1-5% polydimethylsiloxane.

17. A flow sensing system comprising:
a light source;
a light sensor; and
a micro, optomechanical anemometer comprising:
an optical fiber including a fiber core exposed at a face of the optical fiber such that light from the light source can pass out of and into the fiber core;
a stator;
a rotor including one or more blades having a reflective surface for reflecting light from the fiber core back into the fiber core for measurement by the light sensor; and
a gap between the stator and the rotor, wherein
the micro, optomechanical anemometer is positioned at the face of the optical fiber such that, as the rotor rotates, the blades of the rotor pass the fiber core reflecting light from the light source back into the fiber core,
the fiber core receives the light reflected by the reflective surface and transmits it to the light sensor, and
a stabilizing agent is filled in the gap between the stator and the rotor.

18. The flow sensing system of claim 17, wherein the stabilizing agent comprises low volatile petroleum (LVP) aliphatic hydrocarbon.

19. The flow sensing system of claim 18, wherein the stabilizing agent comprises and a polymeric organosilicon compound.

20. The flow sensing system of claim 19, wherein the stabilizing agent is formulated with 85-95% low volatile petroleum (LVP) aliphatic hydrocarbon and 1-5% polydimethylsiloxane.
